(19) United States
(12) Patent Application Publication
(10) Pub. No.: US 2016/0186470 A1
(43) Pub. Date: Jun. 30, 2016

(54) REMOVABLE, REMOTELY-CONTROLLED DOOR LOCKING APPARATUS

(71) Applicants: Kenneth Finley, Arlington, VA (US); Mark Chiaravalloti, Wellington, FL (US)

(72) Inventors: Kenneth Finley, Arlington, VA (US); Mark Chiaravalloti, Wellington, FL (US)

(21) Appl. No.: 14/876,746

(22) Filed: Oct. 6, 2015

Related U.S. Application Data
(60) Provisional application No. 62/060,145, filed on Oct. 6, 2014.

(51) Int. Cl. E05C 17/58; E05C 17/54

(52) U.S. Cl. CPC E05C 17/58; E05C 17/54

(57) ABSTRACT

In order to secure a door in a locked (or locked open) position without a key, such as to resist a forced entry through the door, a removable, remotely-controlled door locking apparatus is provided, which includes a housing configured for temporary fixed engagement to a portion of the door. The housing has a front facing surface sloped forward and downward at an angle from horizontal as taken from a top to a bottom of the apparatus, and an actuator arranged therein so as to be substantially parallel to the sloping front facing surface between upper and lower ends thereof. The apparatus may further include a movable foot attached to the actuator and configured, under actuator control, to be extended in a lock state against a floor surface to secure the door or retracted in an unlock state, based on a wireless signal received from a remote smart device.

### CROSS-REFERENCE TO RELATED APPLICATIONS

The present application claims the benefit under 35 U.S.C. §119(e) of U.S. Provisional Patent Application No. 62/060,145 to Kenneth Finley, filed Oct. 6, 2014, the entire contents of which is hereby incorporated by reference herein.

### BACKGROUND

1. Field

The example embodiments in general are directed to a door locking apparatus, more particularly to an apparatus adapted to provide resistance to a forced entry through the door.

2. Related Art

It may be desirable in many situations to increase the security on a door by, for example, installing a stronger lock or additional locks or bolts at additional locking points around the door. However, it is not always possible or convenient to make these types of permanent installations on a door, for example in a rented home or office, a hotel or hostel room, or in student accommodations.

Thus, in these situations it may be desirable to increase door security using non-permanent means. One well known method is to jam a chair under the door handle, but unless the chair is of proper size and construction, this will not hold the door for long. Another solution of jamming a door closed is by locating a bar at an angle between the door handle and the floor behind the door. While this is an improvement over the use of a chair, the connection between the bar and the door handle is prone to failure, and the bar can extend significantly beyond the door, presenting a trip hazard.

One conventional improvement to the angled bracing bar noted above is shown in FIG. 1. This prior art door brace 10 includes an outer, lower tube 13 within which reciprocates an inner tube 12. The brace 10 is secured at its upper end to a doorknob on a door 14 and has a pivoted foot 17 designed to contact floor 16. A pivot arm 18 normally held in a horizontal position rests against the door 14 to hold the brace 10 at an angle to the door 14.

With brace 10 in its extended condition, the foot 17 engages the floor 16 and prevents the door 14 from swinging to the left. This is accomplished by an internal motor 19 supplied with electrical current from batteries 29. As is well known, the DC motor 19 under power from batteries 29 extends and retracts the inner tube 12 within outer tube 13, so as to raise and lower foot 17. Motor 19 is connected to a gear reduction unit 32 with a recess 33 to receive a splined shaft 34 projecting from the lower tube 13. The splined shaft is rotated by the reduction gears 32 and it is connected to a threaded shaft 36 which threads into a non-rotatable nut 37 secured to the upper end of the inner tube 12. The inner tube 12 (and the nut 37) are prevented from rotating by a pin 38 projecting from the inner tube 12 into a longitudinal slot 39 in the outer tube 13.

The motor 19 is controlled by a radio receiver and associated electronics 21 which may be an off-the shelf arming and disarming circuits. As this brace 10 was developed pre-internet and prior to the smart phone age, coded radio signals are employed. Namely, coded radio waves are sent directly to a radio receiver 21 by a hand held transmitter (not shown). When the code supplied by the transmitter is identical to the code recognized by the receiver 21, the brace 10 under motor 19 control will extend or retract inner tube 12 with the foot 17 attached to the distal end thereof, depending upon the state of a flip-flop in the electronics of the receiver 21.

A more current, commercially available conventional door brace, known as the DOORJAMMERTM™ (sold by Gitway, Inc.) is shown in FIG. 2. The door brace 10′ includes a door engagement member 12′, a leg 20 and an engagement foot 26′. The door engagement member 12′ comprises a bottom flange 14′ and an engagement wall 16′. The bottom flange 14′ is located under a bottom edge of a door 34′, as shown in FIG. 2. The engagement wall 16′ extends generally upwardly from the bottom flange 14′. One face 18′ of the engagement wall 16′ is located against part door 34′, at the bottom edge as shown in FIG. 2. The engagement wall 16′ and bottom flange 14′ together define a generally L-shaped recess for receiving part of the door 34′ at its bottom edge.

The leg 20 comprises a fixed length section 22 and an adjustable length section 24′. In this embodiment, the fixed length section 22 has an angled shape and comprises a first part 22a and a second part 22b. The first part 22a extends in a first elongate direction and the second part 22b extends in the second elongate direction. In the bracing position, the first part 22a extends at a first angle to the face 18′ and the second part 22b extends at a second, smaller angle to the face 18′.

The leg 20 is hingedly connected at one end of its first part 22a to the opposite face of the engagement wall 16′, so as to be moveable relative to the door engagement member 12′ between a bracing position (as shown) and a released position. In the bracing position the leg 20 is spaced from the engagement wall 16′ and in the released position the foot 26′ is located generally adjacent to the engagement wall 16′.

The adjustable length section 24′ of leg 20 is embodied as a threaded bolt located in a threaded aperture within the second part 22b. The adjustable length section 24′ includes a wing nut 28′ for turning the threaded bolt into or out of the fixed length section 22 to shorten or lengthen the adjustable length section 24′. The foot 26′ is provided with a pad 32′ of non-slip material to provide additional resistance to force applied to the door brace 20′.

In use, with the door brace 10′ in its released condition the bottom flange 14′ is underneath the door 34′ and the door brace 10′ is pushed towards the door 34′ until the face 18′ of the engagement wall 16′ is located against part of one side of the door 34′. The leg 20 is then moved from the released to the bracing position, whereby the length of the adjustable length section 24′ is increased by turning the wing-nut 28′, and the non-slip pad 32′ on the foot 26′ contacts the floor 36′. In this position a force applied against the door 34 on the side opposite to the one on which the door brace 10′ is located is transferred into the door brace 10′, and a downwards component of the force is exerted downwardly through the leg 20′ and the foot 26′ into the floor 36′. Any external force on the door 34′ increases the strength of the engagement of the door brace 10′ between the door 34′ and the floor 36′.

### SUMMARY

An example embodiment of the present invention is directed to a removable, remotely-controlled door locking apparatus. The apparatus may include a housing with a vertical rear face having a width and configured for temporary fixed engagement to an opposite-facing portion of a door. The housing may further include a front facing surface having a width, an upper portion of the front facing surface sloping forward and downward at an angle from horizontal as taken from a top of the apparatus to a bottom of the apparatus. The apparatus may further include a powered actuator enclosed within the housing and arranged therein at an angle to horizontal between its upper and lower ends so as to be substantially parallel to the sloping front facing surface, an electronics module attached to the housing and configured to communicate wirelessly, and a foot attached to the lower end of the actuator. The foot may be configured, under actuator control to be extended in a lock state against a floor surface to secure the door or retracted in an unlock state, based on a wireless signal received from a remote smart device by the electronics module to control the actuator.

Another example embodiment is directed to a removable door locking apparatus, which may include a housing configured for temporary fixed engagement to a portion of a door, the housing having a front facing surface, an upper portion of which is sloped forward and downward at an angle from horizontal as taken from a top to a bottom of the apparatus, and an actuator arranged within the housing so as to be substantially parallel to the sloping front facing surface between upper and lower ends thereof. The apparatus may further include a foot attached to the actuator and configured, under actuator control, to be extended in a lock state against a floor surface to secure the door or retracted in an unlock state, based on a wireless signal received from a remote smart device.

Another example embodiment is directed to a removable apparatus adapted to provide resistance against forced entry through a door, which may include a housing configured for temporary fixed engagement to a portion of the door so that a bottom surface of the housing is not in contact with a floor surface, a DC-motor linear actuator enclosed within the housing, a printed circuit board assembly (PCBA) attached to the housing and adapted for communications with a remote smart device, and a power source attached to the housing and configured to provide current to power the PCBA and motor of the actuator. The apparatus may further include a foot located at a bottom of the housing and configured, under actuator control, to be extended so as to contact the floor surface to secure the door in place, based on a communication signal received from a remote smart device by the PCBA to control the actuator.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 shows a side view of a prior art door brace.

FIG. 2 shows a side view of another prior art door brace.

FIG. 3 is a perspective view of a removable, remotely-controlled door locking apparatus according to an example embodiment.

FIG. 4 is an exploded parts view of the apparatus of FIG. 3 to illustrate selected internal components thereof in more detail.

FIG. 5 is a front view of a smart phone illustrates an exemplary display for an application to control the apparatus of FIG. 3 remotely.

FIGS. 6A and 6B are side transparent views of the apparatus of FIG. 3 to illustrate lock and unlock states thereof.

FIG. 7 is a perspective view of a removable, remotely-controlled door locking apparatus according to another example embodiment.

FIG. 8 is a perspective transparent view of the apparatus of FIG. 7 to illustrate selected internal components thereof in more detail.

FIGS. 9A and 9B are perspective views of the apparatus of FIG. 7 installed on a door to illustrate lock and unlock states thereof.

FIG. 10 is an enlarged perspective transparent view of the apparatus of FIG. 7 to illustrate selected indicators and switches on an outer surface thereof in more detail.

FIG. 11 a perspective view of the apparatus of FIG. 7 to illustrate the removability thereof from the door.

FIG. 12 is a perspective view of a key fob for remote control of the apparatus according to any of the example embodiments.

FIG. 13 is an adapter for powering the apparatus of FIG. 7 or recharging batteries therein.

FIG. 14 is a front view of a smart phone illustrating another exemplary display for an application to control the apparatus of FIG. 7 remotely.

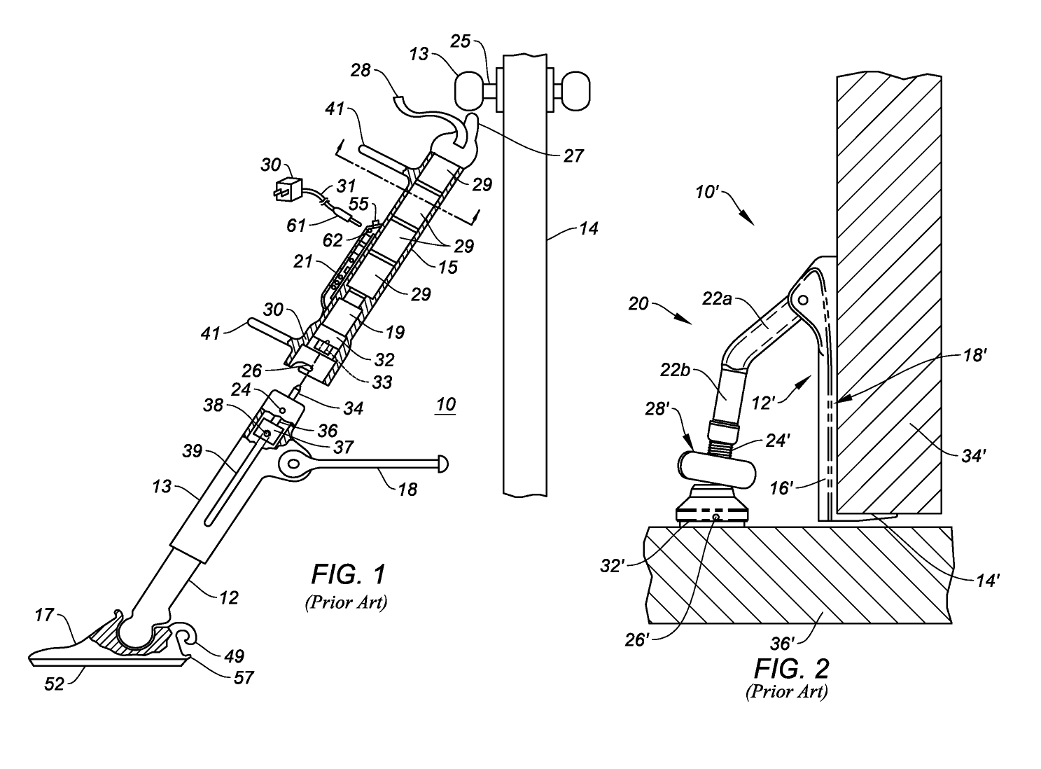

### DETAILED DESCRIPTION

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

As used in the specification and appended claims, the term “smart device” is intended to refer to an electronic device, generally connected to other devices or networks via different wireless protocols such as Bluetooth, NFC, Wi-Fi, 3G, 4G, 5G, WiMAX, etc., that can operate to some extent interactively and autonomously. Example smart devices may include but are not limited to mobile device smartphones such as ANDROID®, BLACKBERRY® and IPHONE®-based systems, phablets and tablets, smartwatches, smart bands, and smart key chains. The term smart device may also refer to a ubiquitous computing device, e.g., a device that exhibits some properties of ubiquitous computing including, although not necessarily, artificial intelligence.

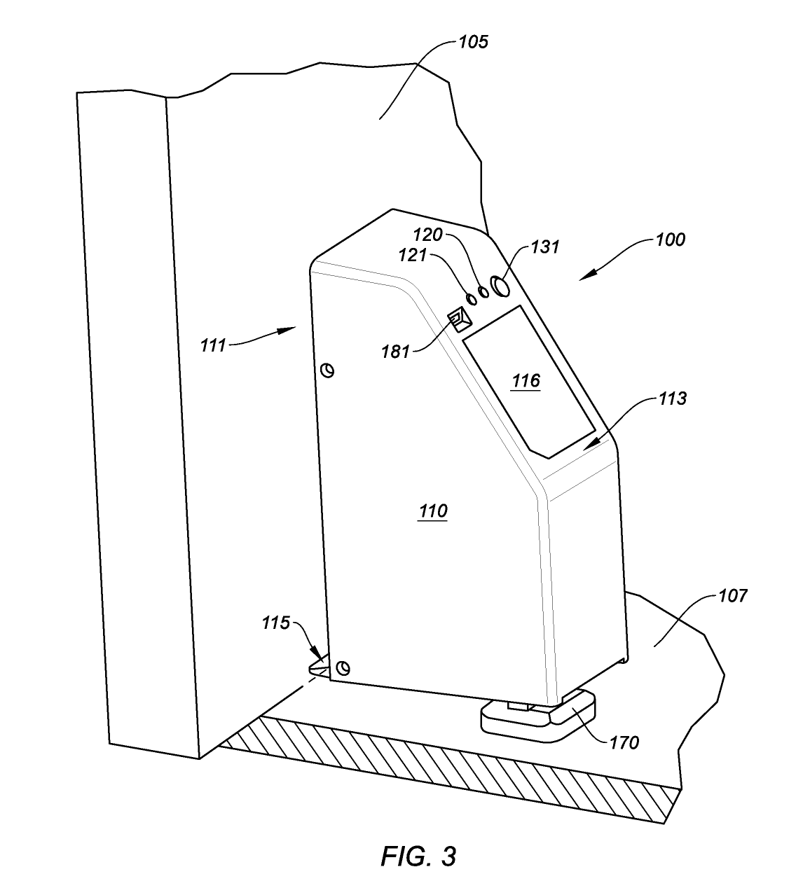

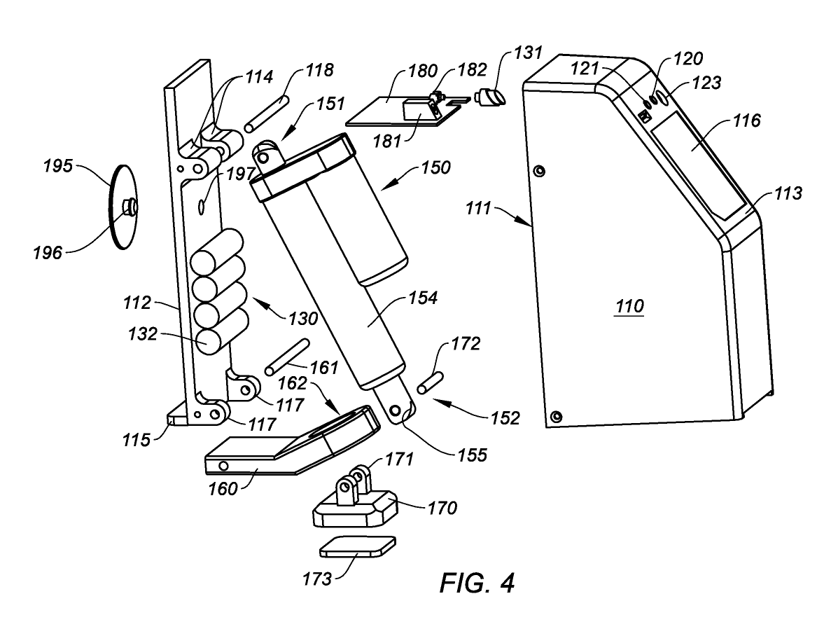

Hereafter, the example embodiments shall describe a removable, remotely-controlled door locking apparatus, or more particularly an apparatus for providing resistance to forced entry through the door. FIG. 3 is a perspective view of a removable, remotely-controlled door locking apparatus according to an example embodiment; and FIG. 4 is an exploded parts view thereof. FIGS. 3 and 4 are provided so as to describe a removable, remotely-controlled door locking apparatus 100. The apparatus 100 is designed to be removably fixed to a portion of a door 105. As shown attached to the door 105, the bottom of the apparatus 100 is not in contact with a floor surface 107, there is a space. Apparatus 100 includes a housing 110 enclosing various mechanical and electrical components. Housing 110 may be constructed primarily from lightweight moldable plastic materials such as moldable plastic, e.g., as a single or multiple parts formed by an injection molding process using a high impact plastic such as Acrylonitrile Butadiene Styrene (ABS). ABS is an easily machined, tough, low cost rigid thermoplastic material with high impact strength, and may be a desirable material for turning, drilling, milling, sawing, die-cutting, shearing, etc. Virgin ABS may be mixed with a plastic regrind of ABS or another lightweight, durable plastic material. ABS is merely an example material, equivalent materials may include various thermoplastic and thermoset materials, such as talc-filled polypropylene, high strength polycarbonates such as GE Lexan®, or blended plastics.

There are many known injection molding machines for forming plastic injection molds, other plastic molding processes such as vacuum forming may be used. Alternatively, housing 110 may be formed using a metal casting process such as sand casting, die casting, or investment casting, for example.

Housing 110 includes an interior metal backing 112 such as aluminum alloy or via an A1 diecast, a pair of interior upper support ribs 114, a pair of lower, spaced interior support ribs 117 and optionally one or more structurally-molded interior intermediate support ribs (not shown) on the inner surfaces of housing 110. There is also an access cover 116 on front facing 113 for access to various components therein. Housing 110 includes a bottom horizontal flange 115 attached to and extending rearward therefrom. When installing the apparatus 100 on door 105, the bottom flange 115 is designed so as to be located under a bottom edge of the door 105, in a space between the door bottom edge and the floor surface 107. This facilitates orienting and securing a rear face 111 of housing 110 flush against the door 105.

The rear face 111 has a width and is therefore configured for temporary fixed engagement to an opposite-facing portion of the door 105. The housing 110 may further include a front facing surface 113. As shown, a substantial upper portion of the front facing surface 113 is shaped so as to slope forward and downward, at an angle from horizontal, as taken from the top of the apparatus 100to the bottom thereof. The shape configuration of housing 110 may therefore account for space savings, so as to minimize the size of the apparatus 100′s overall footprint. In one example, the general dimensions of apparatus 100 may be a width of about 4 inches, a long length (to bottom) of about 8 inches, a short length (horizontal top) of about 2 inches, and a maximum height of about 11 inches.

Additionally, the apparatus 100 includes attachment means to removably attach the rear face 111 of the housing 110 to a portion of the opposite-facing door 105. In an example, the attachment means may be embodied as one or more suction cups 195. As shown in FIG. 4, suction cup 195 may include a flexible elastomeric barb 196 that friction fit attaches to backing 112 at hole 197. In lieu of a suction cup 195, any hook and loop material fasteners such as VELCRO® or an adhesive may be employed to removably attach the apparatus 100 to a surface of the door 105.

As shown, the movable foot 170 is attached to the lower end 152 of the actuator 150. In an example, the foot 170 may include posts 171 connected to the actuator lower end 152 by a pair of metal mounting pins 172, such as cotter pins. These pins 172 also secure an end of a metal horizontal connecting rod 160 (such as one composed of A1-alloy or A1 diecast) to the lower end 152 and foot 170 via the posts 171. Foot 170 includes an elastomeric bottom pad 173 (i.e., silicone or rubberized) that, with the foot 170 in the lock state, provides a frictional surface against the floor surface 107 to facilitate maintaining the door 105 in place.

As previously noted, the foot 170 may be configured, under actuator 150 control, to be extended in a lock state against the floor surface 107 to secure the door 105, or retracted in an unlock state. As will be explained in more detail hereafter, this movement is based on a wireless signal received from the smart device 140 by an electronics module 180 to control a powered actuator 150.

Electronics module 180 is attached to housing 110 and configured to communicate wirelessly with the remote smart device 140, as more fully described hereafter. In one example, module 180 may be embodied as a printed circuit board assembly (PCBA), such as a microcontroller (MCU)—on-chip, capable of BLUETOOTH® wireless short-range communications with a smart device using BLUETOOTH protocols. As is well known, a BLUETOOTH device works by using short-range radio waves (two devices communicating typically up to about 30 feet apart) instead of wires or cables to connect with a smart device. Although not limited to this example, a PCBA with an attached commercially-available BLUETOOTH-capable module or chip usable for module 180 may be a 2.4-GHz BLUETOOTH, low energy System-on-Chip by TEXAS INSTRUMENTS®, part numbers CC2540F128 or CC2540F256. In another example, the BLUETOOTH module or chip installed on electronics module/PCBA 180 may be configured for ANDROID® and IOS® operations, as is known

In another example, wireless fidelity (Wi-Fi) communications may be established between the electronics module 180 and smart device via various standard Wi-Fi protocols, with both being connected to a network. In this configuration module 180 would require a Wi-Fi capable controller. Current Wi-Fi systems support a peak physical-layer data rate of 54 Mbps and typically provide indoor coverage over a distance of about 100 feet. Wi-Fi is based on the IEEE 802.11 family of standards (e.g., 802.11a for wireless Local Area Networks (LANs) with data transfer rates up to 54 Mbps in the 5-GHz band employing an orthogonal frequency division multiplexing (OFDM) encoding scheme as opposed to either the frequency-hopping spread spectrum (FHSS) or direct-sequence spread spectrum (DSSS); 802.11b, for wireless LANs with rates up to 11 Mbps transmission (with a fallback to 5.5, 2 and 1 Mbps depending on strength of signal) in the 2.4-GHz band using only DSSS; and 802.11g for wireless LANs with rates 20+Mbps in the 2.4-GHz band). Accordingly, in a Wi-Fi configuration, the PCBA for module 180 may be embodied as, in one example, a user-dedicated MCU Power Wi-Fi battery-operated chip, such as TEXAS INSTRUMENTS′ CC3200 wireless MCU module.

As shown, the powered actuator 150is attached to or otherwise enclosed within the housing 110, and arranged at an angle to horizontal between its upper end 151 and lower end 152. The upper end 151 is fixed between the upper support ribs 114 via a metal pin 116 such as a cotter pin, and the lower end 152 is connected to the horizontal connecting rod 160 attached at one end via pin 161 between lower support ribs 117, and at its other end to a screw housing 154, which extends through aperture 162 as best shown in FIG. 4. Connecting rod 160 is configured as a purposefully manufactured support plate that locates and guides a lead screw within the screw housing 154 and a traveler rod 155 at a predefined angle of force. As shown, actuator 150 extends within housing 110 substantially parallel to and along the sloping front facing surface 113 thereof. This is another space-saving feature to reduce the footprint of apparatus 100.

Actuator 150 in an example may be embodied as a commercially-available parallel mount, DC-motor linear actuator, as shown in FIGS. 3 and 4, and may comprise a DC motor 153, the lead screw (not shown, within screw housing 154) and the traveler rod 155, which has a proximal end connected to a nut traveling on the lead screw (not shown, within screw housing 154) and a distal end attached to foot 170 between posts 171 thereof.

As is well known in the art, electro-mechanical linear actuators convert rotary motion of DC motor 153 (such as a permanent magnet, stepped or brushless DC motor) into linear displacement. The electric motor is mechanically connected to rotate the lead screw, such as a ball-bearing lead screw for example. The lead screw has a continuous helical thread machined on its circumference running along the length (similar to the thread on a bolt). Threaded onto the lead screw is a lead nut or ball nut with corresponding helical threads. The nut is prevented from rotating with the lead screw (typically the nut interlocks with a non-rotating part within the screw housing 154).

In operation, current in the armature of the DC motor 153 causes a rotary motion of its motor. As the lead screw is rotated by the DC motor 153, the nut will be driven along the threads. The direction of motion of the nut depends on the direction of rotation of the lead screw. By connecting the upper end of the traveler rod 155 (also known as a sliding tube) to the nut, the motion of the lead screw is converted into a usable linear displacement, e.g. the traveler rod 155 with foot 170 attached thereto either is retracted as the lead screw rotates in a first direction based on motor 153 rotation (i.e., with apparatus 100 and/or foot 170 in the unlock state), or the traveler rod 155 with foot 170 moves downward with the nut to the lock state as the lead screw rotates in a second opposite direction under DC motor 153 control. Linear actuators are often supplied with limit switches, such as electro-mechanical, magnetic proximity and rotary cam. These limit switches are designed to control the length of the stroke of the traveler rod 155 for a particular application.

Commercial examples for actuator 150 may include the HB-DJ806 Mini Linear Actuator by WUXI HONGBA MECHANICAL ELECTRICAL EQUIPMENT CO., LTD. of CHINA, or one of the ELECTRAK® 10 Series Electromechanical Linear Actuators offered by DANAHER MOTION® of Marengo, IIl. These parallel mount actuators are suitable for applications where little space is available, as they are compact, reliable and flexible with no maintenance, and deal for lifting or moving flaps, drawers, levers, pistons, rods, and the like. Although the example embodiments are not so limited, typical specifications for these linear actuators include any of a DC Mini permanent magnet motor, brushless DC motor, or stepper motor configured to handle a max load of at least 100N, in an example range between about 100 to 2500N, configured to generate a turning speed from about 5 mm/s to 80 mm/s, and achieving a stroke of about between 20-1100 mm with built-in limit switches.

Accordingly as described above, the actuator 150 may be comprised of the DC motor 153 configured to receive a current signal from the electronics module 180 via a power source 130 within the housing 110, a lead screw (within the screw housing 154) rotatable in two directions under control of the DC motor 153 to translate rotary motion thereof to a linear displacement, the lead screw having a continuous helical thread on its circumference running along a length thereof, and a nut which travels on the threads of the lead screw but does not rotate with the lead screw, the nut having corresponding helical threads threaded on the lead screw. Actuator 150 further includes the elongate traveler rod 155 having its upper end connected to the nut and its lower end connected to the foot 170. The nut is adapted to be driven along the threads of the lead screw as the lead screw rotates in a first direction so that the traveler rod 155 and attached foot 170 extend (lock state), or is adapted to be driven as the lead screw rotates in a second direction so that the traveler rod 155 and attached foot 170 retract (unlock state). Accordingly, in the locked state, any external force on the door 105 increases the strength of the engagement of the apparatus 100 between the door 105 and the floor 107.

Housing 110 may include one or more indicator lamps thereon, which may be LEDs for example. When illuminated, one lamp 120 may indicate that the apparatus 100 is paired (via BLUETOOTH, Wi-Fi, etc.) with the smart device 140, actively in a charging mode, fully charged, and/or also as an indication of an intruder alert. Another lamp 121 may represent a battery level low or battery charging indicator, and/or also as an indication of an intruder alert.

Housing 110 may also include a charging port 181 adapted for receiving external power thereto from a cable, such as a cable connected to AC wall power. In an example, the lamps 120, 121 may function as follows in TABLE 1 for the following operations. As apparatus 100 is configured to be remotely controlled from a user's smart device 140, such as through a downloaded and installed application, metrics displayed to the user on a display of his/her smart device 140 is also noted below in TABLE 1.

TABLE 1
Sample Indicator/Alarm Conditions

| Condition | GREEN LED 120 | RED LED 121 | APP DISPLAY |
|---|---|---|---|
| Battery | OFF | SOLID | BATT ICON LO |
| Low | | ON | (NO BARS) |
| Battery | OFF | BLINKING | CHRG SYMBOL in |
| Charging | | | BATT ICON |
| Battery | ON, SLOW | OFF | BATT ICON ALL |
| Full Charge | BLINK | | BARS SHOWING |
| Apparatus 100 | SOLID ON | OFF | ACTIVATED |
| installed on | | | ICON/MSG |
| door, activated | | | |
| Intruder Alert - | RAPID | RAPID | ALARM |
| force on door | BLINK | BLINK | ICON/SOUND |

The indicator lamps 120, 121, actuator 150 and electronics module 180 are powered by a power supply 130. As shown, the power supply 130 may be embodied as one or more alkaline or rechargeable batteries 132. In the event rechargeable batteries 132 are employed, the electronics module 180 may be configured to include an internal charger thereon. The rechargeable batteries 132 may comprise a battery pack composed of any of lead acid, NiCd, NiMH or lithium ion (Li-ion) battery cells. Optionally, instead of power to apparatus 100 for lock and unlock operations being remotely controlled from a smart device 140, a user may electrically connect the power source 130 to other electrical components therein by simply pressing a power (on/off) button 131, which extends through aperture 123 in housing 110. The on/off button 131 when pressed electrically connects the PCBA 180 with BLUETOOTH module to battery power via power source 130 thereto via a tach switch 182, as shown in FIG. 4.

In a further alternative, the power supply 130 could be solar-powered, where solar cells can be charged by ambient light or by a combination of a rechargeable battery with solar cells to charge the battery. In a further alternative, the solar cells could be adapted to charge a super capacitor (at least about 1F), with the super capacitor providing power to each of the indicator lamps 120, actuator 150 and electronics module 180. In the case that rechargeable batteries 132 are employed, apparatus 100 may include an internal charger (not shown for reasons of clarity) within the housing 110 that is electrically connected to the one or more rechargeable batteries 132.

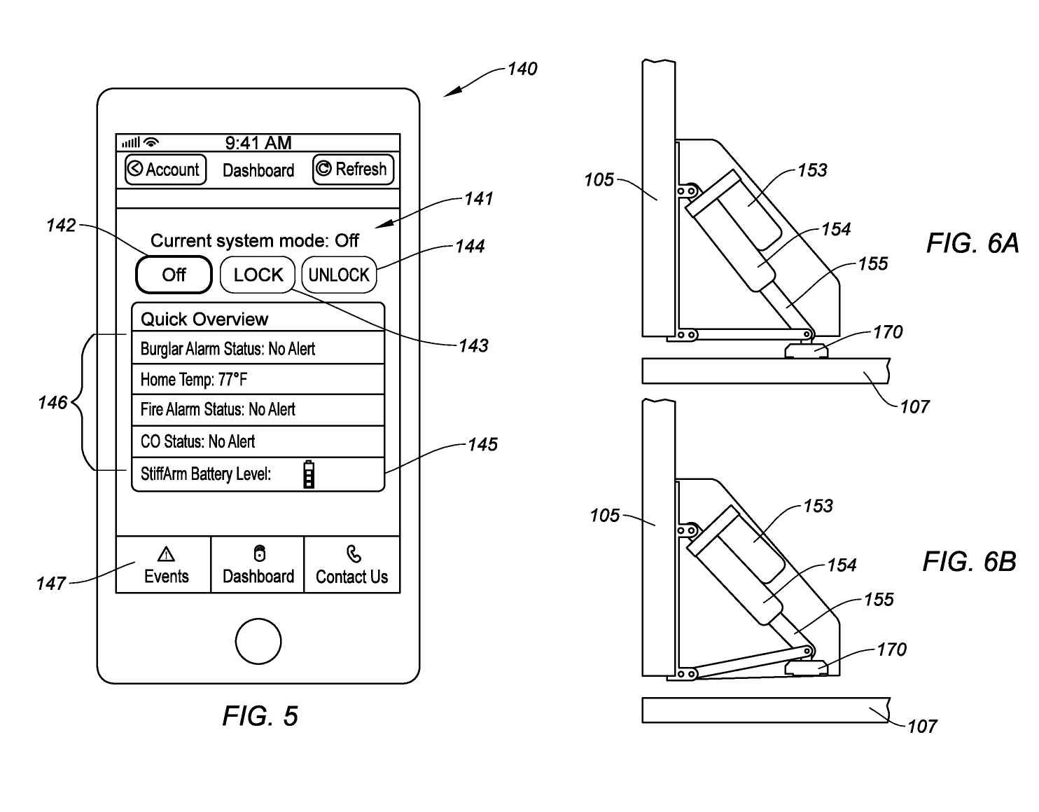

FIG. 5 is a front view of a smart phone to illustrate an exemplary display for an application to control the apparatus of FIG. 3 remotely, and FIGS. 6A and 6B are side transparent views of the apparatus of FIG. 3 to illustrate lock and unlock states thereof. Referring to these figures, before a user of the smart device 140 (here shown as a smartphone) can establish access to apparatus 100 for wireless communications, the devices must be paired, as is well known. For most ANDROID and IPHONE smart devices, this requires authentication via some suitable password, passkey and the like. As an example, to pair apparatus 100 with an ANDROID or IPHONE smart device, the user on his/her device typically will go to “Home”→ “Menu”→ “Settings”→ “Wireless & Networks” (or “Wireless Controls”) →“Bluetooth Settings” to find this feature. The user of smart device 140 would select the Bluetooth box to turn on enabling, and then hold apparatus 100 near the smart device 140. The user then would tap “Scan for Devices”, and wait until the name for apparatus 100 appears for selection/tapping. This connects apparatus 100 to the smart device 140. If the smart device 140 doesn't automatically pair, the user may be prompted enter a passcode or passkey generated for apparatus 100.

Turning to FIG. 5, an assuming that apparatus 100 and smart device 140 have been paired for BLUETOOTH communications, the user may iterate a number of features of an application downloaded and installed on his/her smart device 140 to interface with apparatus 100. In the example of FIG. 5, the application might include the example GUI or display 141 as shown, with “Dashboard”, “Events” and “Contact Us” screens among other pages. In this specific example, the Dashboard screen view may present action icons to be tapped by the user, such as “Off” icon 142, “LOCK” icon 143, and “UNLOCK” icon 144. Additionally, the user may be presented with a visual indicator or icon 145 of battery life and additional information, such as is shown by element number 146 in FIG. 5.

In general, once paired, wireless communications between the user of the smart device 140 to control apparatus 100 can be understood as follows. With the system mode “Off”, no current is applied by power source 130 to the armature of the DC motor 153, the lamps 120 are de-energized, and no current is applied to module 180. Upon selection or tapping the “LOCK” icon 143, the following operations occur:
(a) Armature of DC motor 153 activated;
(b) Lead screw in housing 154 rotates such that nut and traveling rod 155 extend downward from housing 110, which in turn
(c) Pushes foot 170 to floor surface 107 as shown in FIG. 6A, with pad 173 serving as a friction surface to maintain door 105 secured. In this “lock state”, any pressure or force moment exerted against the door 105 from the outside thereof will be translated to apparatus 100, whereby foot 170 is further seated onto floor surface 107 to provide a counterforce.

Conversely, upon selection or tapping the “UNLOCK” icon 144 to change system mode, the following operations occur:
(a) Armature of DC motor 153 activated;
(b) Lead screw in housing 154 rotates in opposite direction from above, such that nut and traveling rod 155 move upward along lead screw into housing 110, which
(c) Retrieves foot 170 from floor surface 107, as shown in FIG. 6B. In the event apparatus 100 becomes compromised, an alarm signal may be sent from module 180 to the smart device 140. An alarm indication will flash on display 141 to alert the user, may be accompanied by sound, and may be recorded by time, date and event on the events page (as shown by action icon 147).

Cyber hacking remains a concern; hence communication via BLUETOOTH protocol should be able to limit the possibility of the application becoming compromised. The application on smart device 140 only works within a certain distance of the apparatus 100, in one example a range of about between 5 to 30 m, in another specific example about 30 feet or less. If a hacker desired access, he/she would need to be already in the user's home specifically looking for that application on the user's smart device 140. This is not likely, and by this time the homeowner would be off to safety. Additionally, Bluetooth is more likely to be turned off on the user's smart device 140 rather than Wi-Fi in order to conserve battery life. Once off, Bluetooth hacking is not possible.

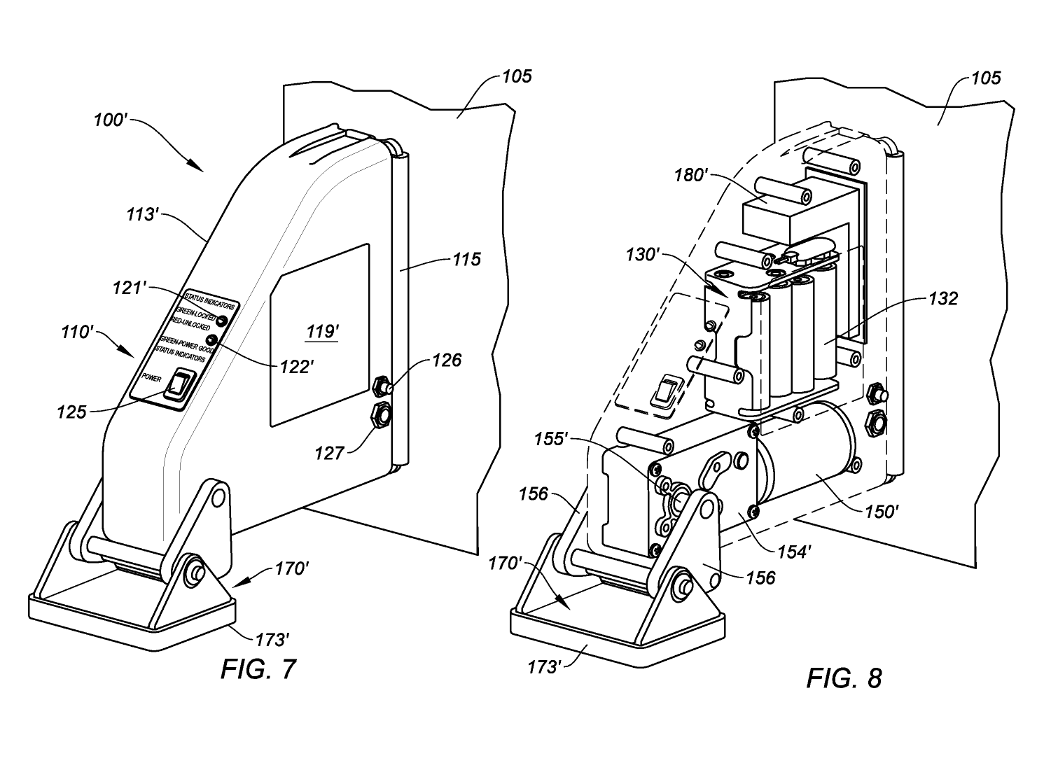

FIGS. 7-14 are various views of a removable, remotely-controlled door locking apparatus according to another example embodiment. As many of the components are the same as compared to the previous embodiment, only the differences are noted in detail. Referring to FIGS. 7-14, and in general, this embodiment illustrates a door securing apparatus 100′ configured so as to secure door 105 in a locked position without the use of a physical key. Similar to the previous embodiment, the housing 110′ of apparatus 100′ has generally the same footprint and shape. Here, movement of a foot 170′ to secure door 105 is powered by an AC motor 150′, the armature of which is energized via a power source 130′ based on a wireless signal received from the smart device 140 by the electronics module, hereafter referred to as PCBA 180′ for example. A wireless radio in a microcontroller (MCU) mounted on PCBA 180′ is capable of acting as a transceiver, implementing protocols associated with any of the NFC, WIFI, 3G/4G/5G, GSM, Bluetooth and ZigBee standards, as well as for other known or developing wireless communication protocols, among various other communications standards. Furthermore, the MCU in PCBA 180′ may be used to wirelessly transmit status notifications to the smart device 140.

Apparatus 100′, like in the previous embodiment, is fixedly removable from door 105. Namely, and as shown in FIG. 11, apparatus 100′ is removably fixed to door 105 via a bracket 115′ located at the base of door 105. Bracket 115′ includes grooves 116′ adapted to receive a tongue portion 117′ along either side of the rear face 111 of housing 110′, so that apparatus 100′ is slidable therein. It is further designed with safety features adapted to disengage the foot 170′ in the event of an emergency or loss of power.

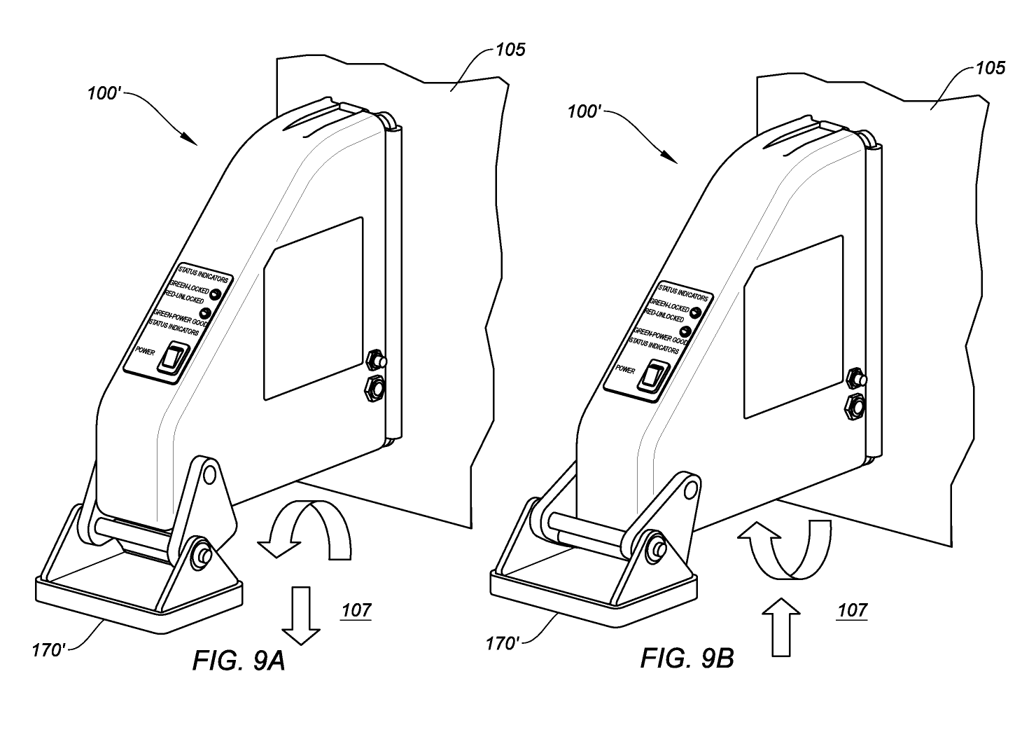

The AC motor 150′ is electrically connected to PCBA 180′ and configured to power a gearbox 154′ (reduction gears with cam shaft) which rotates a horizontal lifting rod 155′ that is fixedly connected to spaced plates 156. Plates 156 in turn are connected to the pivotable foot 170′. Plates 156 move with clockwise or counterclockwise rotation of the rod 155′ (dependent on rotary motion direction of AC motor 150′) to either raise foot 170′ from (or lower it to) the floor surface 107 so that pad 173 comes into frictional contact therewith. Somewhat similar to the previous embodiment, upon the MCU in PCBA 180′ receiving a wireless signal (e.g., locking command) from smart device 140, the armature of AC motor 150 energizes to impart or rotary motion to gearing in gearbox 154′ so as to rotate lifting rod 155′ in a counterclockwise direction (see arrow in FIG. 9A). This lowers foot 170′ toward the floor surface 107, as described previously. The floor 107 exerts a counterforce which causes apparatus 100′ to act as a wedge between the door 105 and floor 107, effectively securing door 105 in place. Alternatively, apparatus 100′ may be employed to lock open door 105. Conversely, upon the microcontroller in PCBA 180′ receiving a different wireless control signal (e.g., unlocking command) from smart device 140, the armature of AC motor 150 energizes to impart or rotary motion to gearing in gearbox 154′ so as to rotate lifting rod 155′ in a clockwise direction (see arrow in FIG. 9B). This raises foot 170 away from the floor surface 107, similar to as described previously.

Housing 110′ may be constructed from any of plastic, steel, aluminum or other metals, natural or synthetic materials, or any other material providing a rigidity that is not explicitly disclosed herein. Housing 110′ may include interior structural ribs, and includes a power supply access door 119′.

Power to the electrical components therein from power supply 130′ is provided by a manual on/off switch 125 on housing 110′. With switch 125 on, the power source 130′, such as a battery pack of alkaline or rechargeable cells 132, powers each of the AC motor 150′, PCBA 180′ and lamps 121, 122. Alternatively, AC wall power may be used in a wired configuration via the AC adapter 135 shown in FIG. 13. The AC adapter 135 includes a connector 137 configured for insertion into AC wall adapter port 127 in housing 110′, and a conventional plug for an outlet. Where the power supply 130′ is a battery pack of rechargeable cells 132, the connector 137 of adapter 135 may be inserted into port 127, with the adapter 135 porting AC wall power to recharge the cells 132.

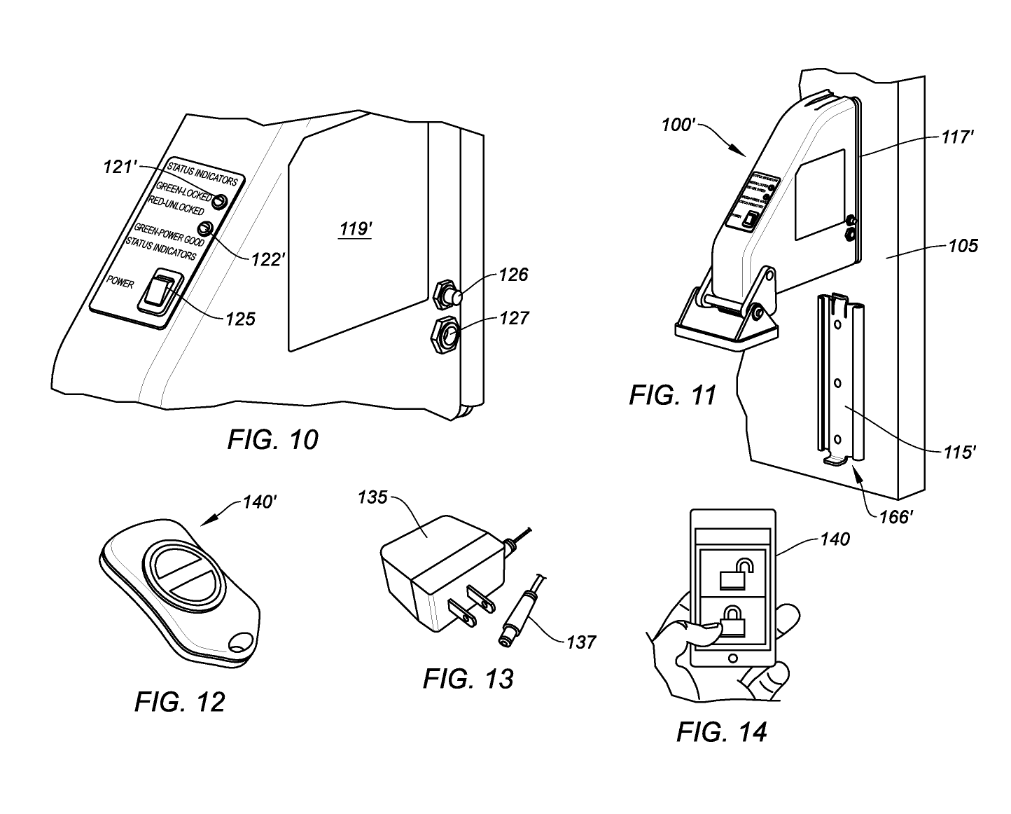

Unlike the previous example embodiment, apparatus 100′ has slightly different indicator lamps thereon. As shown best in FIG. 10, there is a lamp 121′ on housing 110′ which indicates a locked (lamp 121′ green illuminated) or unlocked (lamp 121′ red illuminated) state. There is also lamp 122′ which indicates a battery charged (lamp 122′ green illuminated) or battery power low (lamp 122′ red illuminated) state.

In the previous example embodiment, the smart device 140 was described as being embodied as any of smartphones, phablets and tablets, smartwatches, smart bands and smart key chains, a smartphone example hereby being shown in FIG. 14. Accordingly, a downloaded and installed application on smart device 140 may be used to remotely control apparatus 100′. However, in this embodiment the smart device 140 may alternatively be embodied as a key fob 140′ with intelligent electronics (stored instructions and control commands) therein, as shown in FIG. 12. Housing 110′ thus includes a sync button 126 for fob 140′. The sync button 126 is connected to the MCU on PCBA 180′, so as to enable a user to sync control signals generated by fob 140′ to the wireless radio in the MCU. Once synced, the MCU of PCBA 180′ will accept control signals generated by the synced key fob 140′.

The example embodiments having been described, it is apparent that such have many varied applications. For example, the example embodiments may be applicable but not limited to connection to various devices, structures and articles.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\ or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

We claim:

1. A removable, remotely-controlled door locking apparatus, comprising:
a housing including a vertical rear face having a width and configured for temporary fixed engagement to an opposite-facing portion of a door and a front facing surface having a width, an upper portion of the front facing surface sloping forward and downward at an angle from horizontal as taken from a top of the apparatus to a bottom of the apparatus,
a powered actuator enclosed within the housing and arranged therein at an angle to horizontal between its upper and lower ends so as to be substantially parallel to the sloping front facing surface,
an electronics module attached to the housing and configured to communicate wirelessly, and
a foot attached to the lower end of the actuator, the foot configured under actuator control to be extended in a lock state against a floor surface to secure the door or retracted in an unlock state, based on a wireless signal received from a remote smart device by the electronics module to control the actuator.

2. The apparatus of claim 1, wherein access to the electronics module by the smart device for wireless communications is password protected.

3. The apparatus of claim 1, further comprising:
one or more indicator lamps thereon that when illuminated indicate at least one of the apparatus being enabled for wireless communications with the smart device, a battery level indicator, and an intruder alert indicator.

4. The apparatus of claim 1, wherein the wireless signal is a BLUETOOTH® short radio wave signal received by the electronics module from a smart device.

5. The apparatus of claim 1, wherein the electronics module is embodied as a printed circuit board configured for BLUETOOTH wireless short-range communications with the smart device.

6. The apparatus of claim 1, wherein
the apparatus is configured to be connected to a network, and
the wireless signal is a Wi-Fi communications signal received by the electronics module from the smart device that is connected to the network.

7. The apparatus of claim 1, wherein the electronics module is embodied as a printed circuit board configured for remote communications with the smart device utilizing standard Wi-Fi protocols.

8. The apparatus of claim 1, wherein the remote smart device is selected from a group comprising smartphones, phablets and tablets, smartwatches, smart bands, and smart key chains.

9. The apparatus of claim 1, further comprising:
attachment means to removably attach the rear face of the housing to the opposite-facing door portion.

10. The apparatus of claim 9, wherein the attachment means is selected from a group comprising a suction cup, hook and loop material fasteners, and an adhesive to removably attach the apparatus to a lower surface of the door.

11. The apparatus of claim 1, further comprising:
a bottom horizontal flange attached to and extending rearward from the housing, the bottom flange adapted to be located under a bottom edge of a door in a space between the door bottom edge and a floor surface to facilitate orienting and securing the housing rear face flush against the door.

12. The apparatus of claim 1, further comprising:
a horizontal connecting rod attached between a bottom rear interior surface of the housing and the lower end of the powered actuator where it meets the foot.

13. The apparatus of claim 1, further comprising:
a power supply to power the actuator and electronics module.

14. The apparatus of claim 13, wherein the power supply is embodied as one or more alkaline or rechargeable batteries.

15. The apparatus of claim 14, further comprising:
an internal charger within the housing that is electrically connected to the one or more rechargeable batteries.

16. The apparatus of claim 1, wherein the foot includes an elastomeric bottom surface that, with the foot in the lock state, provides a frictional surface against the floor to facilitate maintaining the door in place.

17. The apparatus of claim 1, wherein the powered actuator is embodied as a DC linear actuator, the DC linear actuator further including:
a DC motor configured to receive a current signal from the electronics module via a power source within the housing,
a lead screw rotatable in two directions under control of the DC motor to translate rotary motion thereof to a linear displacement, the lead screw having a continuous helical thread on its circumference running along a length thereof,
a nut which does not rotate with the lead screw, the nut having corresponding helical threads threaded on the lead screw, and
an elongate traveler rod having its upper end connected to the nut and its lower end connected to the foot, the nut adapted to be driven along the threads of the lead screw as the lead screw rotates in a first direction so that the traveler rod and attached foot extend to a lock state, or adapted to be driven as the lead screw rotates in a second direction so that the traveler rod and attached foot retract to an unlock state.

18. A removable door locking apparatus, comprising:
a housing configured for temporary fixed engagement to a portion of a door, the housing having a front facing surface, an upper portion of which is sloped forward and downward at an angle from horizontal as taken from a top to a bottom of the apparatus,
an actuator arranged within the housing so as to be substantially parallel to the sloping front facing surface between upper and lower ends thereof, and
a foot attached to the actuator and configured, under actuator control, to be extended in a lock state against a floor surface to secure the door or retracted in an unlock state, based on a wireless signal received from a remote smart device.

19. The apparatus of claim 18, wherein the wireless signal is a BLUETOOTH short radio wave signal sent by the smart device.

20. A removable apparatus adapted to provide resistance to a forced entry through a door, comprising:
a housing configured for temporary fixed engagement to a portion of the door so that a bottom surface of the housing is not in contact with a floor surface,
a DC-motor linear actuator enclosed within the housing,
a printed circuit board assembly (PCBA) attached to the housing and adapted for communications with a remote smart device,
a power source attached to the housing and configured to provide current to power the PCBA and motor of the actuator, and
a foot located at a bottom of the housing and configured, under actuator control, to be extended so as to contact the floor surface to secure the door in place, based on a communication signal received from a remote smart device by the PCBA to control the actuator.

21. The apparatus of claim 20, wherein the apparatus is enabled for BLUETOOTH communications with the smart device.
